(19) United States
(12) Patent Application Publication
(10) Pub. No.: US 2011/0146624 A1
(43) Pub. Date: Jun. 23, 2011

(54) FUEL DELIVERY INJECTION SYSTEM

(75) Inventors: Massimo LUCANO, Alessandria (IT); Vincenzo RAMPINO, Torino (IT)

(73) Assignee: GM GLOBAL TECHNOLOGY OPERATIONS, INC., Detroit, MI (US)

(21) Appl. No.: 12/908,629

(22) Filed: Oct. 20, 2010

(30) Foreign Application Priority Data
Oct. 20, 2009 (GB) 0918404.5

(51) Int. Cl. F02M 69/46

(52) U.S. Cl. 123/456

(57) ABSTRACT

A fuel delivery injection system that includes, but is not limited to a fuel tank connected to a high pressure fuel pump. The fuel is pumped from the pump and distributed to direct acting piezoelectric injectors by means of a distribution hydraulic circuit. An electronic control unit controls the pump, the injectors and receives the pressure indications from a control valve associated to said distribution circuit. The distribution circuit includes, but is not limited to a small distribution rail having a volume of about 4-6 cm³ and the pipes connecting the rail to the injectors having a dimension of about 3 mm or slightly higher.

### CROSS-REFERENCE TO RELATED APPLICATION

This application claims priority to British Patent Application No. 0918404.5, filed Oct. 20, 2009, which is incorporated herein by reference in its entirety.

### TECHNICAL FIELD

The present invention refers to a fuel delivery injection system, in particular to a more efficient fuel delivery injection system for vehicles in which piezoelectric injectors are used.

### BACKGROUND

The known injection systems for diesel engines, conventionally called common rail systems, firstly comprises a pump for the generation of a high pressure, hereinafter called high pressure fuel pump, an accumulator (rail), injectors and pressure control valves and pipes which connect the previous elements. The rail receives the fuel delivery from a fuel tank and by means of said pump distributes it to the injectors into the combustion chamber. The pressure control valve is used to fine-tune the rail pressure to the demanded one, based on the system dynamics. The low pressure fuel flows coming from the leakage injectors as well as from the pressure control valve are then routed back to the tank by means of a dedicated low pressure piping.

One of the major drawbacks of this system is the energy consumption required by the high pressure pump, which could represent up to 50% of the total fuel consumption. In addition, the packaging can be critical and the injection pattern stability can be reduced due to the propagation of pressure waves inside the high pressure pipes connected to the different injectors. In addition, other drawbacks, desirable features, and characteristics will become apparent from the subsequent summary and detailed description, and the appended claims, taken in conjunction with the accompanying drawings and this background.

### SUMMARY

A direct supply of fuel from the pump is provided to the piezoelectric injectors and this directly exploits the needle actuation of the force provided by the piezoelectric actuator, instead of the fuel pressure provided by the accumulator (rail). The energy necessary to generate the force in the piezoelectric actuator is provided by an electronic driver.

An embodiment of the present invention concerns a fuel delivery injection system comprising: a fuel tank connected to a fuel pump, in particular a high pressure fuel pump, said fuel pump being fluidly connected to a plurality of directly acting piezoelectric injectors. The latter connection is established by means of a fuel-distributing hydraulic circuit. This distribution circuit has a volume of less than approximately 13 cm³, preferably less than approximately 12 cm³ or even less than approximately 11 cm³.

This fuel delivery injection system thus replaces well-known accumulators (rails) with the small distribution circuit which ensures an operation where less energy is needed. For that reason the volume of said distributing volume is smaller than the usual volume of an accumulator. The distribution volume can be arbitrary in shape, e.g. can have the shape of a sphere or of a rail, and has a volume of about approximately 4-6 cm³.

A further embodiment has a distribution circuit with a plurality of pipes connecting the distributing volume with the injectors, whereby the pipes have an inner diameter of more than approximately 3 mm, preferably more than approximately 3.1 mm, more than approximately 3.2 mm, more than approximately 3.3 mm or more than approximately 3.4 mm. Thus the pipes are larger in diameter than normal such that they additionally, albeit partly, obtain the function of a supplementary accumulator in addition to the distributing volume. If desired, the volume of the distribution volume can be decreased to values of less than approximately 4 cm³ in such cases.

### BRIEF DESCRIPTION OF THE DRAWINGS

The present invention will hereinafter be described in conjunction with the following drawing figures, wherein like numerals denote like elements, and:

FIG. 1 is a block scheme of the fuel delivery injection system according to an embodiment of the present invention; and

FIG. 2 is a diagram of the pressure oscillations of a conventional injection system, using a common rail, and a system according to an embodiment of the present invention.

### DETAILED DESCRIPTION

The following detailed description is merely exemplary in nature and is not intended to limit application and uses. Furthermore, there is no intention to be bound by any theory presented in the preceding background or summary or the following detailed description.

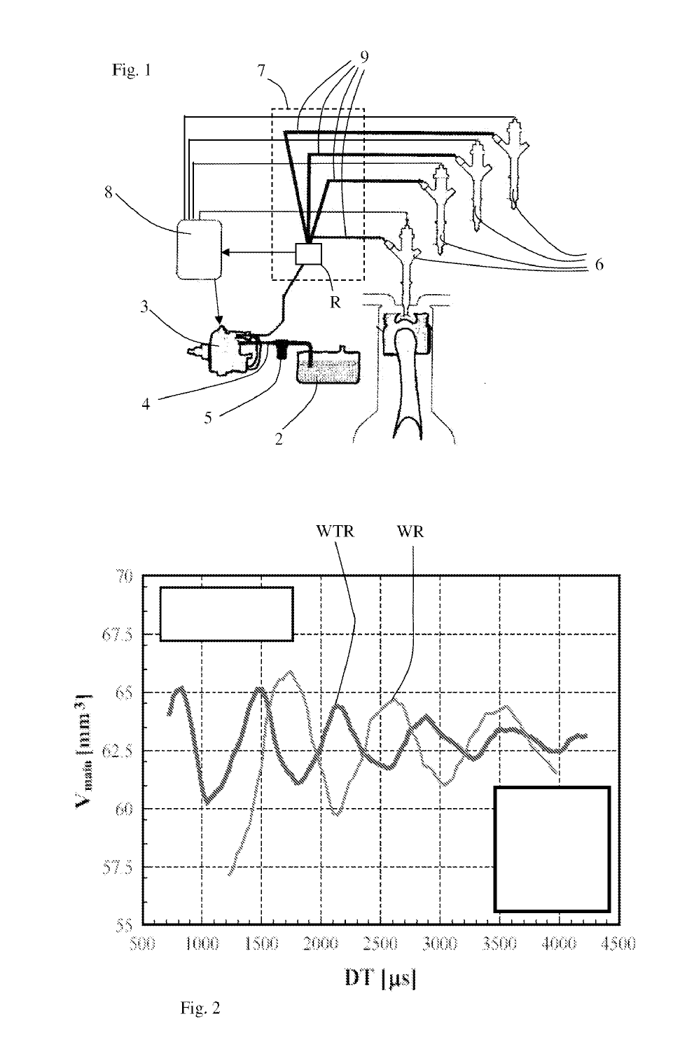

According to FIG. 1, the system of the present invention comprises a fuel tank 2 connected to a high pressure fuel pump 3 by means of a first duct 4. Along such a duct, it is advantageously provided a fuel filter 5. The fuel pumped from the pump 3 is distributed to a plurality of direct acting piezoelectric injectors 6, by means of a distribution hydraulic circuit 7. An electronic control unit 8 controls the pump 3 and the injectors 6 and receives the pressure indications from a control valve (not shown) associated to said distribution circuit.

The fuel is directly delivered by the high pressure pump to the injectors, using the distribution circuit 7 comprising a distribution volume and a plurality of pipes 9 connecting the distribution volume to the injectors 6 having predetermined dimensions. The pressure control valve is used to fine-tune the rail pressure to the demanded one. In particular, the dimensions of said distribution volume are smaller than the dimensions of the traditional common rail accumulator and furthermore such distribution rail R may have an arbitrary shape. For example, a common rail accumulator has a volume of about approximately 10-13 cm³; the distribution volume according to an embodiment of the present invention can have a volume of about approximately 4-6 cm³, preferably approximately 5 cm³.

The remaining volume wherein the fuel has to be pressurized is obtained by enlarging the injection pipes 9 with respect to the pipes of the prior art injection systems. In particular, increase from approximately 2.4 (mostly applied) to >approximately 3 mm inner diameter of said pipes is possible. A preferred diameter is equal or more than approximately 3.1 mm.

The small size of the distribution volume does affect neither the injector characteristics nor substantially the pressure oscillations as shown in the diagram of FIG. 2. In said diagram a first curve WR shows the pressure oscillations in a traditional system provided with a common rail accumulator and a second curve WTR shows the pressure oscillations in the system of the present invention. In particular, the amplitude of the injected volume fluctuations as DT reduces when injector feeding pipes with larger internal diameters are used.

The fluctuation amplitude of the injected volume is mainly influenced by the inlet pipe size rather than by the accumulation volume. The direct acting piezoelectric injectors guarantee a small fuel amount or zero amount coming from the actuation and leakage injectors.

The system of the present invention reduces the cost of the high pressure fuel system and improves the packaging, the fuel economy and the durability thanks to the rail elimination and the downsizing of the high pressure fuel injection pump. The fuel economy improvement, in turn, reduces vehicle CO2 emissions, especially considering that the fuel and therefore the energy consumption for the actuation injector is relatively higher in NEDC cycle area, where the vehicle fuel consumption is evaluated for homologation/certification.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A fuel delivery injection system, comprising:
a fuel tank;
a fuel pump that is adapted pump fuel from the fuel tank;
a plurality of directly acting piezoelectric injectors; and
a fuel-distributing hydraulic circuit connecting the plurality of directly acting piezoelectric injectors to the fuel pump, said fuel-distributing hydraulic circuit having a volume of less than approximately 13 cm³.

2. The fuel delivery injection system according to claim 1, further comprising:
a control valve; and
an electronic control unit, the electronic control unit adapted to control the fuel pump, adapted to control the plurality of directly acting piezoelectric injectors, and adapted to receive a pressure indication from the control valve associated to said fuel-distributing hydraulic circuit.

3. The fuel delivery injection system according to claim 1, wherein the volume has a rail shape.

4. The fuel delivery injection system according to claim 1, wherein the volume has a spherical shape.

5. The fuel delivery injection system according to claim 1, wherein the volume is less than approximately 12 cm³.

6. The fuel delivery injection system according to claim 1, wherein the volume is less than approximately 11 cm³.

7. The fuel delivery injection system according to claim 1, wherein the volume is less than approximately 10 cm³.

8. The fuel delivery injection system according to claim 1, further comprising a plurality of pipes connecting the fuel-distributing hydraulic circuit with the plurality of directly acting piezoelectric injectors, the plurality of pipes have an inner diameter larger than approximately 3 mm.

9. The fuel delivery injection system according to claim 8, wherein the inner diameter is greater than approximately 3.1 mm.

10. The fuel delivery injection system according to claim 8, wherein the inner diameter is greater than approximately 3.2 mm.

11. The fuel delivery injection system according to claim 8, wherein the inner diameter is greater than approximately 3.3 mm.
